(19) United States
(12) Patent Application Publication
(10) Pub. No.: US 2003/0056183 A1
(43) Pub. Date: Mar. 20, 2003

(54) Scan test circuit, and semiconductor integrated circuit including the circuit

(76) Inventor: Munenori Kobayashi, Tokyo (JP)

Correspondence Address: KATTEN, MUCHIN, ZAVIS, ROSENMAN, 575 MADISON AVENUE, NEW YORK, NY, 10022-2585, US

(21) Appl. No.: 09/491,631

(22) Filed: Jan. 26, 2000

(30) Foreign Application Priority Data
Jan. 26, 1999 (JP) 17641/1999

(51) Int. Cl. G06F 17/50; G06F 17/60

(52) U.S. Cl. 716/4

(57) ABSTRACT

The present invention discloses a scan test circuit capable of dealing with the cases of various numbers of pins without being restricted by the number of scan pins of a semiconductor integrated circuit tester, and a semiconductor integrated circuit including the scan test circuit. When the number of scan chains within the chip of an LSI to be tested is n, the number of scan inputs given from the outside of the LSI is m, and the number of scan outputs output to the outside of the LSI is p, this scan test circuit is equipped with a scan input conversion circuit which carries out bit number conversion of m→n, and a scan output conversion circuit which carries out bit number conversion of n→p.

### BACKGROUND OF THE INVENTION

1. Field of the Invention

The present invention relates to a scan test circuit including a scan input conversion circuit and a scan output conversion circuit which converts the number of scan paths and input/output pins as well as timings between the scan paths and the input/output pins of a semiconductor integrated circuit, and a semiconductor integrated circuit including the scan test.

2. Description of the Related Art

The scan test technique of preparing one or a plurality of scan paths connecting serially the inputs and the outputs of the internal registers for the purpose of testing the internal circuitry of a semiconductor integrated circuit has been adopted widely since old days. Combinational circuits within the internal circuit are placed between the registers of the scan paths. One of the reasons for adopting the scan test technique is that the observation and fault detection of the internal circuits of a large scale integrated circuit (LSI) are becoming increasingly difficult due to advancement in the scale and the intricacy of internal functions of the recent LSIs.

FIG. 12 is a diagram for explaining the scan test of a semiconductor integrated circuit according to a conventional technique. In the Figure, there are provided four scan chains that constitute the scan paths, and PIN_i0, PIN_i1, PIN_i2 and PIN_i3, are four inputs for scan test given to the four chains from the outside of the semiconductor integrated circuit. Actually, signals a pattern data for scan test are input through these input terminals for scan test.

Signals given to these input terminals PIN_i0 to PIN_i3 for scan test are sent successively forwarded on the scan chains (4 in the Figure), each connecting serially the internal registers, and are eventually output to the outside of the semiconductor integrated circuit from four output terminals PIN_o0, PIN_o1, PIN_o2 and PIN_o3 of the scan chains. The number (4 in this example) of the inputs and the outputs is restricted in reality by the number of input/output pins for scan test prepared on the semiconductor integrated circuit package and the number of input/output pins for scan test equipped on the tester for testing the semiconductor integrated circuit.

The scan test according to the conventional technique will be described referring to a more specific example. FIG. 13 is an example of a circuit diagram showing a combinational circuit element group, a register group, and paths that connect them, within a semiconductor integrated circuit, where the number of the scan paths is four the same as in FIG. 12. In the Figure, Logic00 to Logic44 are circuit elements representing combinational circuits, and S10 to S44 expressed as scan cells represent the registers. There are four scan chains, and a scan input entering through SCANIN0, for example, propagates passing through successively scan cells S10→S11→S12→S13→S14 and is output from SCANOUT0.

Similarly, scan input data entering through SCANINn (n=1, 2, or 3) propagate vertically on a scan chain and are output from SCANOUTn. The combinational circuit elements and the registers are illustrated as being arranged in a matrix form in FIG. 13, and data stored in the scan cells are sent in downward direction along the arrows in the scan test mode and are sent in rightward direction along the arrows in the normal operation mode.

To describe the operation in FIG. 13 by referring to a timing chart in FIG. 14, a TESTMode signal goes to the scan test mode when its value is at an ‘H’ level and the data propagate vertically downward along the scan chain in FIG. 13, whereas it goes to the normal operation mode when its value is at an ‘L’ level and the data propagate horizontally rightward and are output from a NORMAL_OUTPUTn (n=0 to 4). Besides, SC Clock in FIG. 14 is a common clock signal supplied to the scan cells S10 to S44.

First, the TESTMode is brought to the ‘H’ level, and inputs A, B, C, D and E are given to SCANIN0 in respective cycles of the SC_Clock, and these inputs are sent successively through scan cells S10→S11→S12→S13→S14 to let them take on the values S10=E, S11=D, S12=C, S13=B and S14=A. Next, the TESTMode is switched to the ‘L’ level, and data V, W, X, Y and Z are given to the scan cells S10, S11, S12, S13 and S14, respectively, through from NORMAL_INPUT0 to NORMAL_INPUT4.

At the same time, the values of the scan cells S10, S11, S12, S13 and S14 are stored in the scan cells S20, S21, S22, S23 and S24 through combinational circuits Logic10, 11, 12, 13 and 14, respectively. Furthermore, after these values are stored in respective scan cells, the TESTMode is brought back again to the ‘H’ level, and the data are propagated between the scan cells by means of the scan test mode. By selecting and combining the scan test mode and the normal operation mode as in the above, it is possible to carry out diversified types of test.

A semiconductor integrated circuit having the above scan path test circuit is tested by using an LSI tester for logic LSI. Among recent LSI testers for logic LSI there are appearing those which are adapted to test LSIs with 512 or even 1024 input/output terminals to cope with the increase in the number of pins for logic LSI. In contrast, the capacity of the test patterns memory of the LSI testers for logic LSIs is at the most on the order of 10 megapatterns per terminal. As the test patterns for input/output terminals that are not connected to the scan path chains, a number of this order suffices. On the other hand, for terminals connected to the inputs and the outputs of scan path chains, test patterns more than 1 Gbits per scan chain are necessary.

Under these circumstances, among the recent LSI testers for logic LSI there are appearing those that are provided with a pattern memory dedicated to scan path test that has a pattern depth of more than 1 Gbits, though the width of the test pattern is small being that for 8 to 16 scan chains.

However, there exist cases in which an appropriate scan path test are not feasible even by the use of such an LSI tester provided with test functions dedicated to the scan path test.

Namely, if the scan path test function of an LSI tester is for 8-scan chains, an LSI with 16-scan chains cannot be tested in a single operation, and has to be tested in two operations of 8-scan chains each.

Moreover, if an LSI has 8-scan chains, even an LSI tester with test function for 16-scan chains is unable to exhibit its high speed testing capability because only the test patterns for scan chains of 8, which is half of its full power, is available. In particular, it should be noted that the bottleneck in the high speed LSI test is often due to the input delay of an input pattern to the LSI and the delay of the output from the output terminal of the LSI, rather than the operational delay inside the LSI.

### SUMMARY OF THE INVENTION

Accordingly, it is an object of the present invention to provide a novel scan test circuit, and a novel semiconductor integrated circuit including the circuit those avoid these problems of the related art.

It is another object of the present invention to provide a novel scan test circuit capable of dealing with the cases of various number of pins without being restricted by the number of scan pins of the semiconductor integrated circuit tester, and a semiconductor integrated circuit including the scan test circuit.

These and other objects of the present invention will be apparent to those of skill in the art from the appended claims when read in light of the following specification and accompanying Figures.

### BRIEF DESCRIPTION OF THE DRAWINGS

FIG. 1 is a block diagram showing a portion related to internal circuit scan paths of an LSI according to a first embodiment of the present invention, and a block diagram of a scan cell;

FIG. 2 is an internal circuit diagram of the scan cell in FIG. 1;

FIG. 3 is a circuit diagram of a scan input conversion circuit 10;

FIG. 4 is a circuit diagram of a scan output conversion circuit 11;

FIG. 5 is a timing chart at data conversion in the scan input conversion circuit 10;

FIG. 6 is a timing chart at data conversion in the scan output conversion circuit 11;

FIG. 7 is a block diagram showing a portion related to internal circuit scan paths of the LSI according to a second embodiment of this invention;

FIG. 8 is a circuit diagram of a scan input conversion circuit 70;

FIG. 9 is a circuit diagram of a scan output conversion circuit 71;

FIG. 10 is a timing chart at data conversion in the scan input conversion circuit 70;

FIG. 11 is a timing chart at data conversion in the scan output conversion circuit 71;

FIG. 12 is an explanatory diagram for scan chains of a semiconductor integrated circuit according to conventional technique;

FIG. 13 is a circuit diagram showing the combinational circuit element group, the register group and the paths connecting them inside the semiconductor integrated circuit; and

FIG. 14 is a timing chart for describing the operation of the circuit in FIG. 13.

### DESCRIPTION OF THE PREFERRED EMBODIMENTS

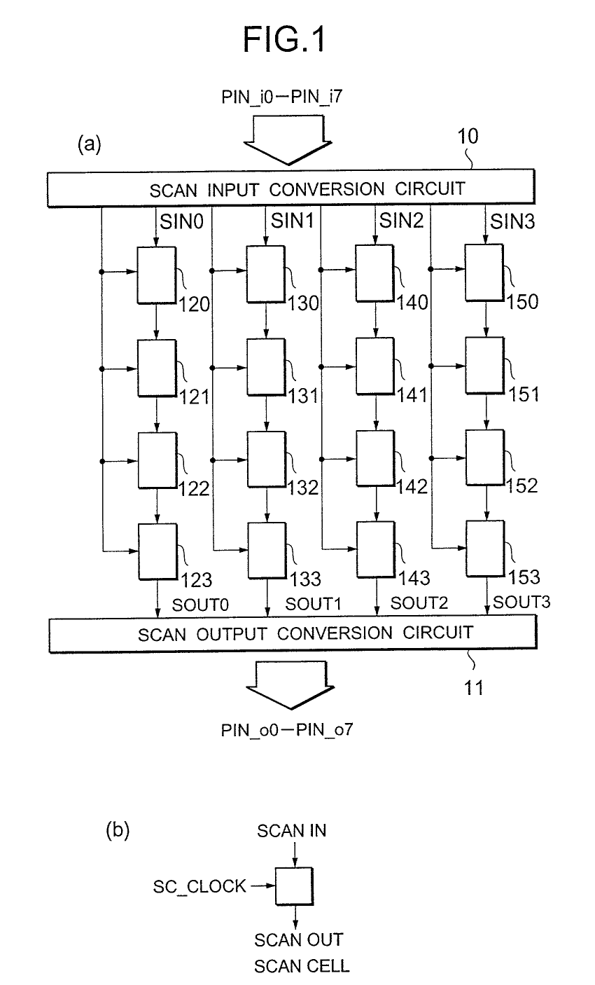

FIG. 1(a) is a block diagram of a portion related to the scan paths of the internal circuits of an LSI according to a first embodiment of this invention. In this embodiment, it is assumed that 8-bit data for scan are given from the outside of the LSI, scan test of the internal circuits of the LSI is performed by 4 scan chains, and the result of the test is output to the outside of the LSI as 8-bit data.

In the LSI in FIG. 1(a), there are provided eight input pins, PIN_i0 to PIN_i7 for inputting scan test data from the outside, and eight output pins PIN_o0 to PIN_o7 for outputting the result of the test to the outside. Further, inside the LSI there are provided four scan chains, and the inputs from the PIN_i0 to PIN_i7 pass through a scan input conversion circuit 10 to be parallel to serial converted into four scan input signals SIN0, SIN1, SIN2 and SIN3. Four scan output signals SOUT0, SOUT1, SOUT2 and SOUT3 that passed the scan chains are serial to parallel converted by a scan output conversion circuit 11 to be output from eight output pins PIN_o0 to PIN_o7.

One of the scan input signals, SIN0, propagates serially through scan cells 120, 121, 122 and 123 to become a scan output signal SOUT0. The same situation applies to other scan input signals. Thus, a scan input signal SIN1 propagates serially through scan cells 130, 131, 132 and 133 and appears as a scan output signal SOUT1. A scan input signal SIN2 propagates serially through scan cells 140, 141, 142 and 143 to appear as a scan output signal SOUT2. Finally, a scan input signal SIN3 propagates serially through scan cells 150, 151, 152 and 153 to appear as a scan output signal SOUT3.

The structure of each scan cell is such that it has a SCANIN as a terminal for a scan input signal, a SCANOUT as a terminal for a scan output signal, and SC_Clock as a terminal for the scan clock, as shown in FIG. 1(b).

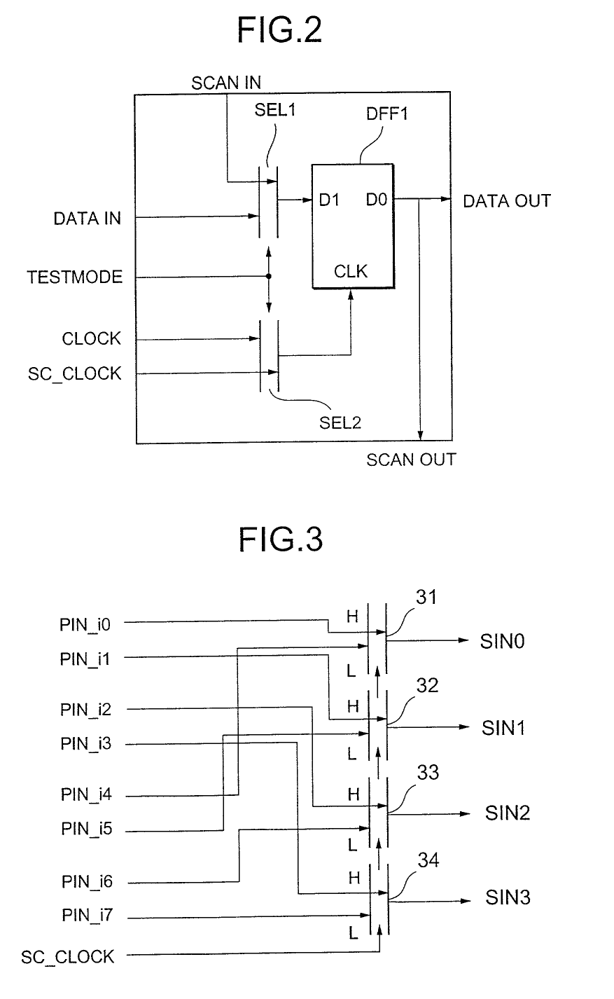

The internal circuitry of the scan cell is illustrated in FIG. 2. As shown, SCANIN and DATAIn are given as the input terminals of a 2-input 1-output selector SEL1, and Clock and SC_Clock are given as the input terminals of a 2-input 1-output selector SEL2. An input signal at scan test, a data input signal in normal operation, a clock signal in normal operation, and a scan clock signal at scan test are given to SCANIN, DATAIn, Clock, and SC_Clock, respectively. These inputs to the selectors SEL1 and SEL2 are all selected by a signal TESTMode, in which SCANIN and SC_Clock are selected when the value of the signal TESTMode is at the ‘H’ level, and DATAIn and Clock are selected when it is at ‘L’ level.

The outputs of the selectors SEL1 and SEL2 are connected respectively to a data input DI and a clock input CLK of a flip-flop DFF1. Data output DO of the flip-flop DFF1 is connected to the output terminals DATAOut and SCANOUT of the scan cell, where the output terminal DATAOut is used in normal operation and the output terminal SCANOUT is used at scan test.

The internal circuit configuration of the scan input conversion circuit 10 is shown in FIG. 3. In this example, four of 2-input 1-output selectors called respectively 31, 32, 33 and 34 are provided, and the input signals for these selectors are selected by the clock SC_Clock. For example, for the selector 31, the PIN_i0 which is an H input is selected and it is output as a scan output signal SIN0 when the clock SC_Clock is at the ‘H’ level, and an input PIN_i4 which is an L-input is selected and it is output as a scan output signal SIN0 when the clock SC_Clock is at the ‘L’ level. The output SIN0 is input to the scan cell 120 as shown in FIG. 1(a). In other words, two inputs are alternately output corresponding to the change between ‘H’ and ‘L’ levels of the clock SC_Clock. The remaining selectors 32, 33 and 34 operate in the same way.

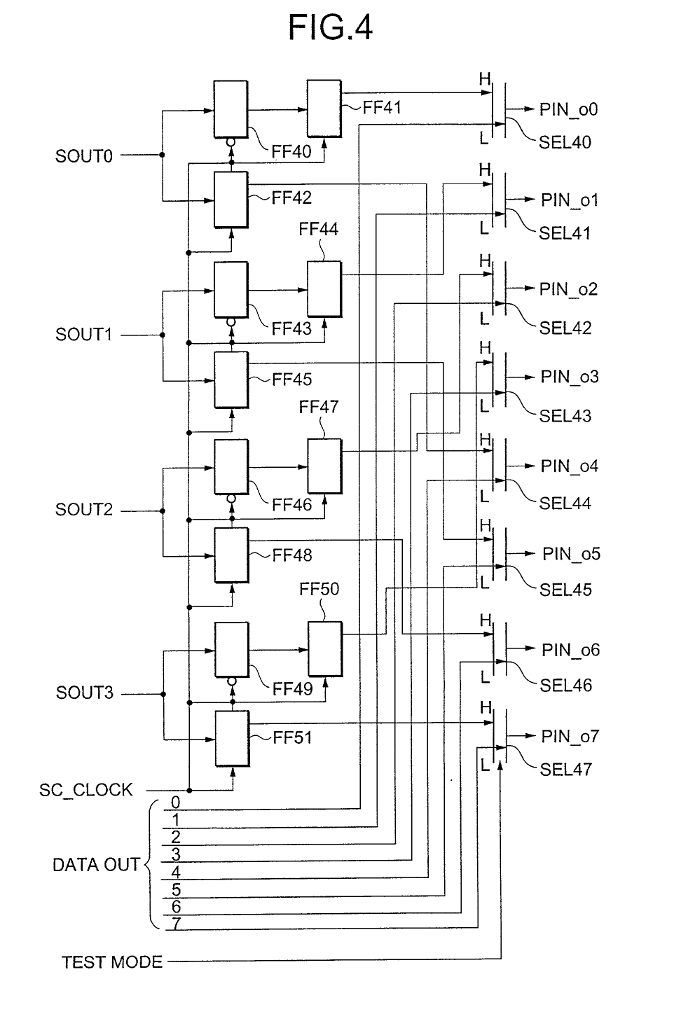

Next, the circuit configuration of the scan output conversion circuit 11 shown in FIG. 4 will be described. In this circuit 11, four scan output signals SOUT0 to SOUT3 are given as inputs, and after internal conversion processing is completed, the result is output from output pins PIN_o0, PIN_o1, PIN_o2, PIN_o3, PIN_o4, PIN_o5, PIN_o6 and PIN_o7. First, as seen from FIG. 1(a), the scan output signal SOUT0 which is the output of the scan chain is input to the scan output conversion circuit 11, and inside the circuit 11 it is input to the data input terminals of flip-flops FF40 and FF42. The output of the FF40 is input to a flip-flop FF41, and the output of the FF41 is input to the H-input of a selector SEL40, while the output of the FF42 is input to the H-input of a selector SEL44.

In addition, the L-input of the SEL40 receives a signal DATAOut0 which is the output of a normal operation data from a register such as a flip-flop inside the LSI, other than the flip-flops included in the scan input conversion circuit 10 and the scan output conversion circuit 11, while the L-input of the selector SEL44 receives a signal DATAOut4.

In this way, the output of the selector SEL40 is output from the output pin PIN_o0, and the output of the selector SEL44 is output from the output pin PIN_o4. The selection signal of both of the selectors SEL40 and SEL44 is the signal TESTMode, and the H-input and L-input of the selectors are selected when the values of the TESTMode is at the ‘H’ level and the ‘L’ level, respectively. This is common to all the selectors, namely, SEL41 to SEL47 in FIG. 4. Moreover, the flip-flops FF41 and FF42 fetch data at the rise of the clock SC_Clock and the flip-flop 40 fetches data at the fall of the clock SC_Clock.

Similarly, the signal SOUT1 is input to the H-input of the selector SEL41 through flip-flops FF43 and FF44, and to the H-input of a selector SEL45 through a flip-flop FF45. Furthermore, the L-inputs of the selectors SEL41 and SEL45 receive signals DATAOut1 and DATAOut5, respectively. The outputs of the selectors 41 and 45 are output from output pins PIN_o1 and PIN_o5, respectively. The flip-flops FF44 and FF45 fetch data at the rise of the clock SC_Clock, and the flip-flop FF43 fetches data at the fall of the clock SC_Clock.

Similarly, the signal SOUT2 is input to the H-input of a selector SEL42 through flip-flops FF46 and FF47, and to the H-input of a selector SEL46 through a flip-flop FF48. Furthermore, the L-inputs of the selectors SEL42 and SEL46 receive signals DATAOut2 and DATAOut6, respectively. The outputs of the selectors SEL42 and SEL46 are output from output pins PIN_o2 and PIN_o6, respectively. The flip-flops FF47 and FF48 fetch data at the rise of the clock SC_Clock, and the flip-flop 46 fetches data at the fall of the clock SC_Clock.

Similarly, the signal SOUT3 is input to the H-input of a selector SEL43 through flip-flops FF49 and FF50, and to the H-input of a selector SEL47 through a flip-flop 51. Furthermore, the L-inputs of the selectors SEL43 and SEL47 receive signals DATAOut3 and DATAOut7, respectively. The outputs of the selectors SEL43 and SEL47 are output from the output pins PIN_o3 and PIN_o7, respectively. The flip-flops FF50 and FF51 fetch data at the rise of the clock SC_Clock, and the flip-flop FF49 fetches data at the fall of the clock SC_Clock.

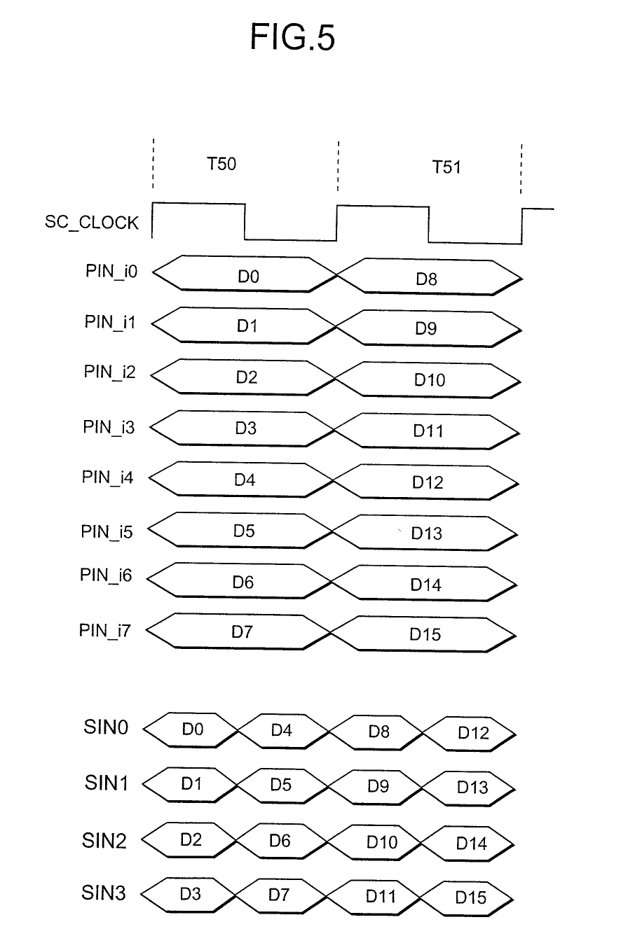

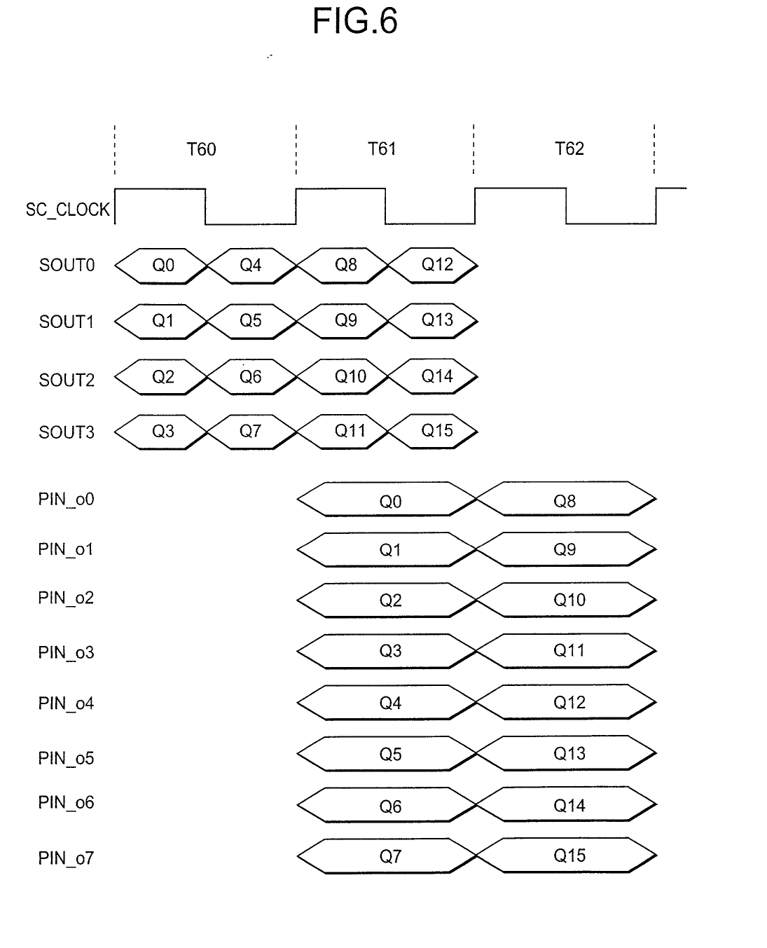

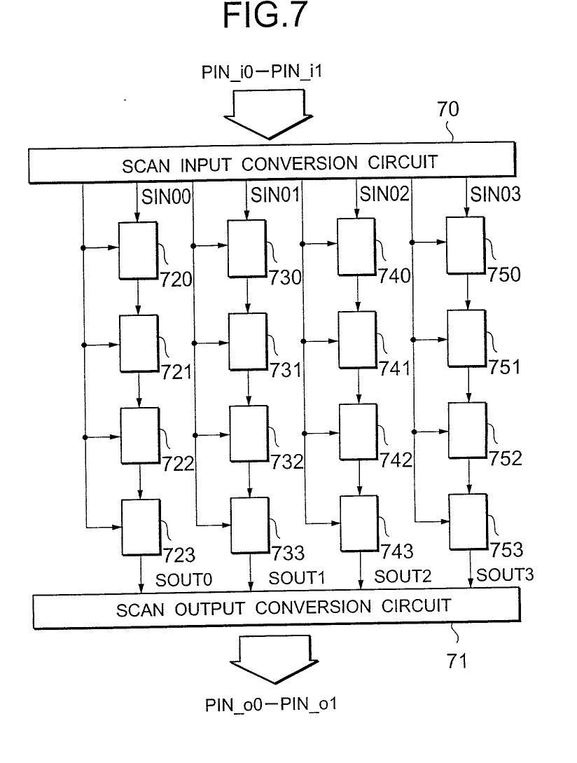

Next, referring to FIG. 5 and FIG. 6, the data conversion which takes place in the circuit of the first embodiment in the above will be described. FIG. 5 shows timings for converting 8-bit data to 4-bit data in the scan input conversion circuit 10. As a result of input and conversion of 8-bit data input to the circuit 10 through the input pins PIN_i0 to PIN_i7, 4-bit data of scan input signals SIN0 to SIN3 are output. First, when D0 to D7 are given as data to the PIN_i0 to PIN_i7 in a cycle T50 of the scan clock SC_Clock, as the outputs of the SIN0 to SIN7, there are output data D0 to D3 for the section where SC_Clock is at ‘H’, and data D4 to D7 are output in the section where SC_Clock is at ‘L’ due to switching of input selection of the selectors 31 to 34, as may be clear from the description about the circuit in FIG. 3.

In the next cycle T51 of the scan clock SC_Clock, next 8-bit data D8 to D15 are input through the input pins PIN_i0 to PIN_i7. In response to this, to the output pins SIN0 to SIN3, there are output data D8 to D11 in the section where SC_Clock is at ‘H’, and data D12 to D15 are output in the following section where SC_Clock is at ‘L’, due to switching of input selection of the selectors 31 to 34. In other words, in the scan input conversion circuit 10, the input signals change for every cycle of the SC_Clock, and the corresponding output signals are switched between the section in which the SC_Clock is at ‘H’ and the section in which the SC_Clock is at ‘L’ within the same cycle. In this way, an 8-bit input signal is converted to a 4-bit scan input signal by means of the scan clock SC_Clock.

FIG. 6 shows timings in converting 4-bit data to 8 bit data in the scan output conversion circuit 11. In the figure, it will be assumed that the signal TESTMode stays at ‘H’. When 4-bit data of scan output signals SOUT0 to SOUT3 are input to the circuit 11, 8-bit data are output to the output pins PIN_o0 to PIN_o7 as a result of the conversion. First, during a cycle T60, SOUT0 to SOUT3 receive data Q0 to Q3 respectively in the section where SC_Clock is at ‘H’, and Q4 to Q7 respectively in the section where SC_Clock is at ‘L’. In the next cycle T61, 8 bits of the Q0 to Q7 are output to the output pins PIN_o0 to PIN_o7.

In the cycle T61, the SOUT0 to SOUT3, receive Q0 to Q11, respectively, in the section where SC_Clock is at ‘H’, and Q12 to Q15 respectively in the section where SC_Clock is at ‘L’. In the next cycle T62, 8 bits of Q8 to Q15 are output to the output pins PIN_o0 to PIN_o7. In other words, in the scan output conversion circuit 11, the input signals change for every half cycle of the SC_Clock, and the corresponding output signals change for every one cycle, delayed by one cycle relative to the input signals. In this way, a 4-bit input signal is converted to an 8-bit scan output signal by means of the scan clock SC_Clock.

Next, referring to the drawings, a scan test circuit according to a second embodiment of this invention will be described.

In FIG. 7, to an internal circuit with built-in scan chains having the same configuration as in the first embodiment, 2-bit data are input to the input pins PIN_i0 and PIN_i1 from the outside of the LSI. Inside the LSI, scan test is performed using four scan chains, and the result is output to the outside of the LSI as 2-bit data. Accordingly, a scan input conversion circuit 70 is a 2-bit input 4-bit output serial to parallel conversion circuit, and a scan output conversion circuit 71 is a 4-bit input 2 bit output parallel to serial conversion circuit.

Since scan input signals SIN0 to SIN3, scan output signals SOUT0 to SOUT3 input pins PIN_i0 and PIN_i1, and output pins PIN_o0 and PIN_o1 have the same configurations as those in the first embodiment in FIG. 1(a), the same symbols as those in the first embodiment will be given to the corresponding components in this embodiment. Furthermore, the configuration and the mode of data propagation of the circuit sandwiched between the scan input conversion circuit 70 and the scan output conversion circuit 71 are the same, including scan cells 720 to 723, 730 to 733, 740 to 743 and 750 to 753 which are the constituent elements, as those in the first embodiment in FIG. 1(a), and hence the scan cell 720, for example, is the same as the scan cell 120. Accordingly, repetitive description about them is omitted, and only the scan input conversion circuit 70 and the scan output conversion circuit 71 which are the features of this embodiment will be described.

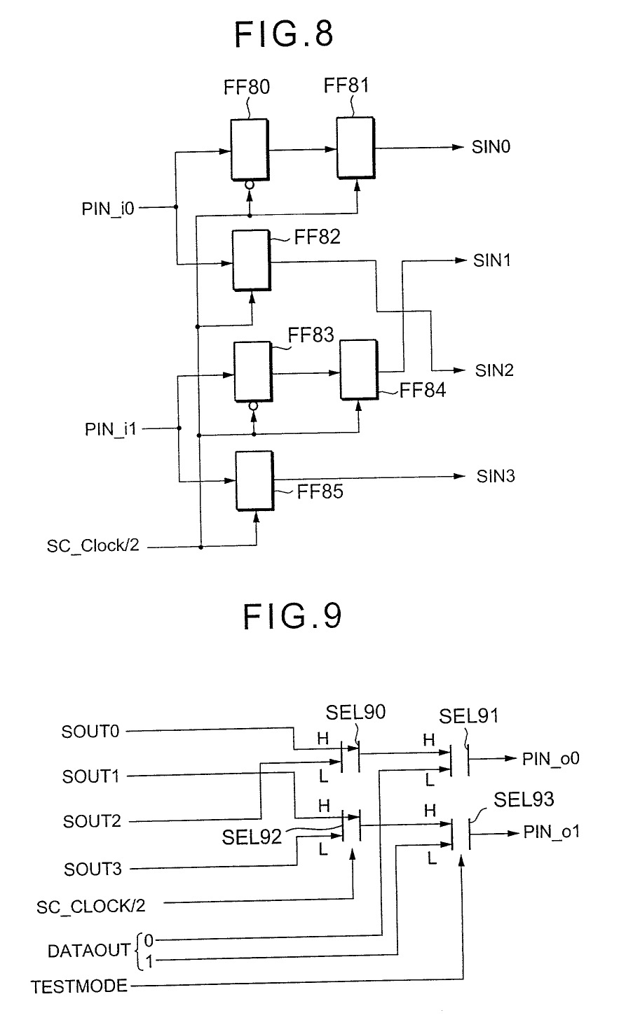

In FIG. 8 showing the circuit configuration of the scan input conversion circuit 70, when an input signal is input to the circuit 70 through the input pin PIN_i0, it is input inside the circuit 70 to the data input terminals of flip-flops FF80 and FF82. The output of the FF80 is input to a flip-flop FF81 and the output of which is output as a scan input signal SIN0, while the output of the FF82 is output as a scan output signal SIN2.

Similarly, the input from the input pin PIN_i1 is input within the scan input conversion circuit 70 to the data input terminals of flip-flops FF83 and FF85. The output of the FF83 is input to a flip-flop FF84 and the output of which is output as the scan input signal SIN1, and the output of the FF85 is output as the scan input signal SIN3. The flip-flops FF81, FF82, FF84 and FF85 fetch data at the rise of clock SC_Clock/2, and the flip-flops FF80 and FF82 fetch data at the fall of the clock SC_Clock/2. The clock SC_Clock/2 is the clock which corresponds to the case where the frequency of the SC_Clock used in the first embodiment is divided by two.

Next, to describe the circuit configuration, shown in FIG. 9, of the scan output conversion circuit, 4 scan output signals SOUT0 to SOUT3 are input, and 2 signals PIN_o0 and PIN_o1 are output. First, the scan output signals SOUT0 and SOUT1 are input respectively to the H-input and the L-input of a selector SEL90, and the scan output signals SOUT2 and SOUT3 are input respectively to the H-input and the L-input of a selector SEL92. Furthermore, the output of the SEL90 and the signal DATAOut0 are input respectively to the H-input and the L-input of the SEL91, and the output of the SEL92 and the signal DATAOut1 are input respectively to the H-input and the L-input of a SEL93.

The signals DATAOut0 and DATAOut1 are the outputs at the normal operation of the internal circuits of the LSI analogous to the first embodiment. The outputs of the SEL91 and SEL93 are led to the output pins PIN_o0 and PIN_o1, respectively. Furthermore, the selection signal used in the selectors SEL90 to SEL93 is the TESTMode, and the H-input and the L-input of respective selectors are selected when the TESTMode is at ‘H’ and ‘L’, respectively.

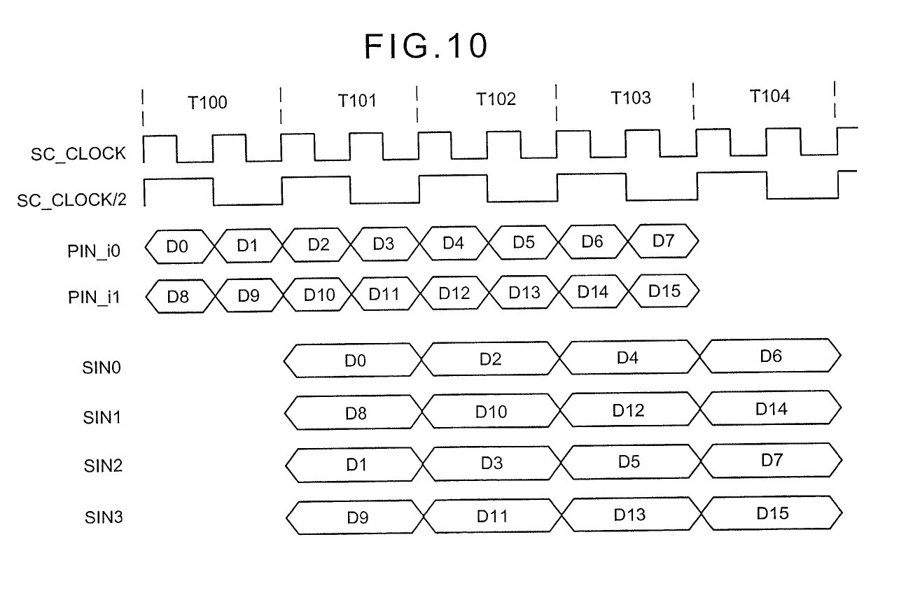

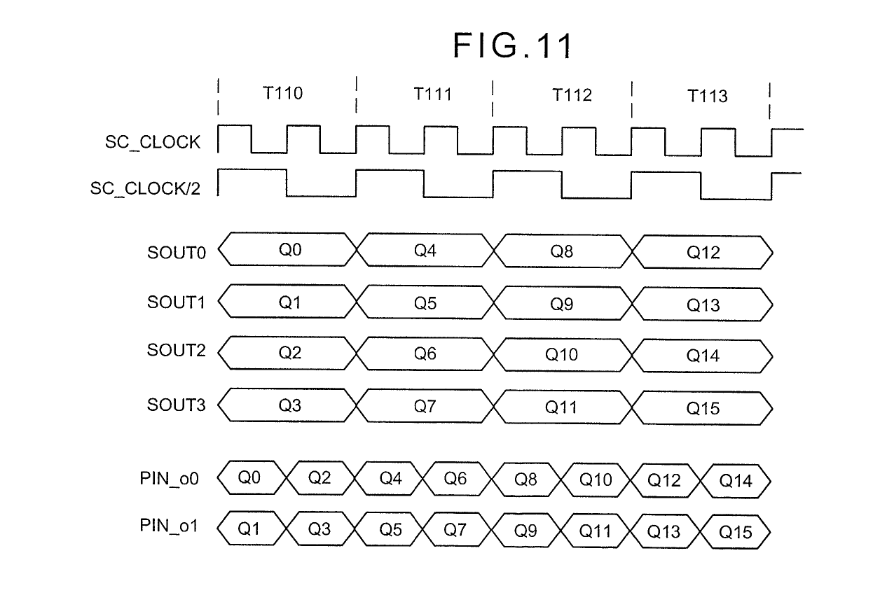

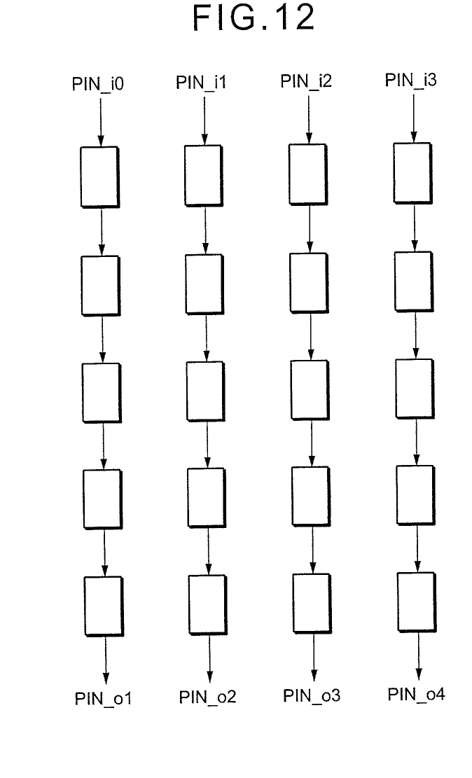

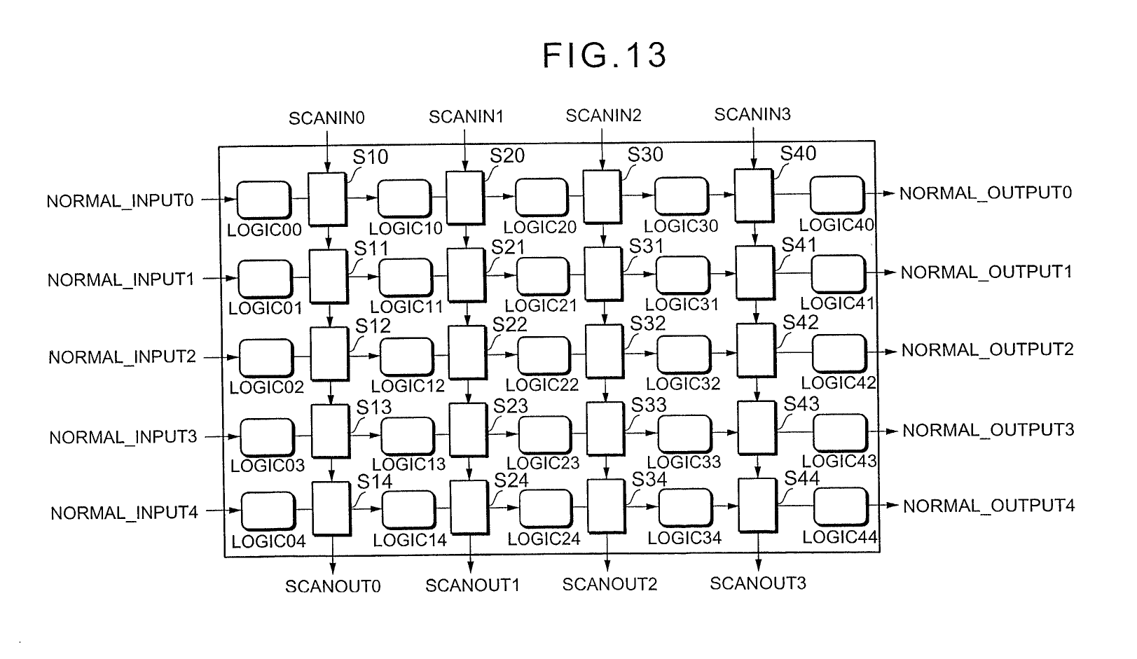

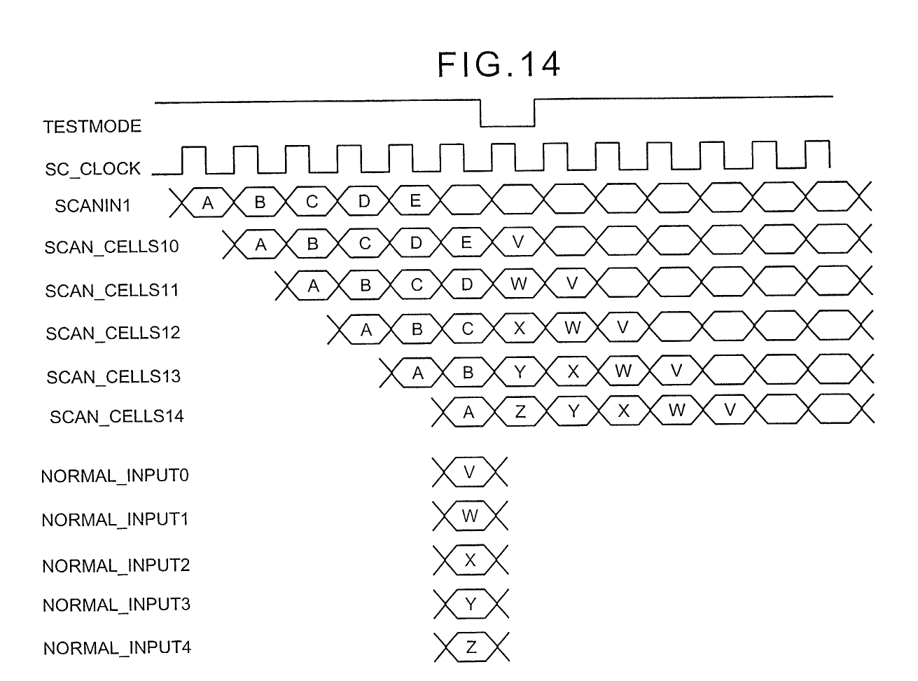

Next, referring to FIG. 10 and FIG. 11, the data conversion taking place in the circuit of the second embodiment will be described. FIG. 10 shows the timings in converting 2-bit data to 4-bit data in the scan input conversion circuit whose circuit configuration is shown in FIG. 8. As a result of input of 2-bit data to the scan input conversion circuit 70 from the input pins PIN_i0 and PIN_i1, and its conversion, 4 bits of scan input signals SIN0 to SIN3 are output. As shown in FIG. 8, SC_Clock/2 is used as the clock for the flip-flops, but in FIG. 10, the clock SC_Clock is also shown as a reference. Furthermore, the cycle of the clock SC_Clock/2 is used to represent the cycle.

First, in a cycle T100, the input pins PIN_i0 and PIN_i1 receive data D0 and D8 in the section where the clock SC_Clock/2 is at ‘H’, and data D1 and D9 in the section where the clock SC_Clock/2 is at ‘L’, respectively. In response to this, during the period of one cycle of the next cycle T101, the values of D0, D8, D1 and D9 are output to the scan output signals SIN0, SIN1, SIN2 and SIN3, respectively. During the same cycle T101, the values of the data D2 and D10 are given in the section where the clock SC_Clock/2 is at ‘H’, and the values of the data D3 and D11 are given in the section where the clock SC_Clock/2 is at ‘L’, to the input pins PIN_i0 and PIN_i1, respectively.

Similarly, in the next cycle T102, the input pins PIN_i0 and PIN_i1 receive the data of D4 and D12 respectively in the section where the clock SC_Clock/2 is at ‘H’, and the values of data D5 and D13 respectively in the section where the clock SC Clock/2 is at ‘L’. During the same cycle T102, the values of D2, D10, D3 and D11 are output to the scan output signals SIN0, SIN1, SIN2 and SIN3, respectively.

Similarly, in the succeeding cycle T103, the input pins PIN_i0 and PIN_i1 receive the values of data D6 and D14 in the section where the clock SC_Clock/2 is at ‘H’, and the values of data D7 and D15 in the section where the clock SC_Clock/2 is at ‘L’. During the same cycle T103, the values of data D4, D12, D5 and D13 are output to the scan output signals SIN0, SIN1, SIN2 and SIN3, respectively.

In the next cycle T104, the values D6, D14, D7 and D15 are output to the scan output signals SIN0, SIN1, SIN2 and SIN3, respectively. As in the above, in the scan input conversion circuit 70, in a certain cycle of the clock SC_Clock/2, data of a total of 2 bits×2=4 bits, input by time division from the two input pins PIN_i0 and PIN_i1, are output 4 bits in parallel as the scan output signals SIN0, SIN1, SIN2 and SIN3 in the next cycle with a delay of one cycle.

FIG. 11 shows the timings in the conversion of 4-bit data into two bits in the scan output conversion circuit 71 shown in FIG. 9. In the figure, it will be assumed that the signal TESTMode stays at ‘H’ level. As shown in FIG. 9, SC_Clock/2 is used as the clock for the flip-flops, but the clock SC_Clock is also shown in FIG. 11 for reference. Furthermore, the cycle of the clock SC_Clock/2 is used to represent the cycle.

First, in a cycle T110 in FIG. 11, values of Q0, Q1, Q2 and Q3 are supplied to the scan output signals SIN0, SIN1, SIN2 and SIN3, respectively, during the whole period of the cycle. By selecting the H-input for all the selector SEL90 to SEL93 shown in FIG. 9, the output pins PIN_o0 and PIN_o1 are given Q0 and Q1, respectively, in the section where the clock SC_Clock/2 is at ‘H’, and are given Q2 and Q3, respectively, in the section where the clock SC_Clock/2 is at ‘L’.

In the succeeding cycle T111, values of Q4, Q5, Q6 and Q7 are supplied to the scan output signals SIN0 and SIN1, respectively, during the whole period of the cycle. The output pins PIN_o0 and PIN_o1 receive Q4 and Q5, respectively, in the section where the clock SC_Clock/2 is at ‘H’, and Q6 and Q7, respectively, in the section where the clock SC_Clock/2 is at ‘L’.

Similarly, in the next cycle T112, the values of Q8, Q9, Q10 and Q11 are given to the scan output signals SIN0, SIN1, SIN2 and SIN3, respectively, during the whole period of the cycle. The output pins PIN_o0 and PIN_o1 receive the values of Q8 and Q9, respectively, in the section where the clock SC_Clock/2 is at ‘H’, and the values of Q10 and Q11, respectively, in the section where the clock SC_Clock/2 is at ‘L’.

In the next cycle T113, the scan output signals SIN0, SIN1, SIN2 and SIN3 receive respectively the values of Q12, Q13, Q14 and Q15 during the whole period of the cycle. The output pins PIN_o0 and PIN_o1 receive Q12 and Q13 respectively in the section where the clock SC_Clock/2 is at ‘H’, and Q14 and Q15 respectively in the section where the clock SC_Clock is at ‘L’.

As described in the above, in the scan output conversion circuit 71, out of 4-bit data input to the scan output signals SOUT0, SOUT1, SOUT2 and SOUT3 in a certain cycle of the clock SC_Clock/2, the data applied to the scan output signals SOUT0 and SOUT1 are output in the section where the clock SC_Clock/2 is at ‘H’, and the data applied to the scan output signals SOUT2 and SOUT3 are output respectively in the section where the clock SC_Clock/2 is at ‘L’ during the same cycle by time division mode.

In the above, the scan test circuit of this invention has been described a first and a second embodiments. In realizing the scan test circuit of this invention, the circuit may be incorporated into an LSI which is the object of the test, to form a single chip, or it may be made into a board for testing a semiconductor integrated circuit by incorporating the scan input conversion circuit and the scan output conversion circuit into a semiconductor circuit tester.

As described in the above, by using the scan test circuit according to this invention it is possible to deal with cases of various numbers of pins of a semiconductor integrated circuit to be tested, without being restricted by the number of scan pins equipped on the semiconductor integrated circuit tester.

While preferred embodiments of the present invention have been described, it is to be understood that the invention is to be defined by the appended claims when read in light of the specification and accorded their full range of equivalent.

What is claimed is:

1. A scan test circuit for testing a digital circuit comprising:
a plurality of scan paths formed by serially connecting registers in a semiconductor integrated circuit provided for testing the digital circuit;
a scan input conversion circuit which receives signals from a plurality of input terminals and translates them to the scan paths by converting the number and the timings of the received signals;
and a scan output conversion circuit which converts signals from the scan paths to a plurality of output terminals by converting the number and the timings of the output signals.

2. The scan test circuit as claimed in claim 1, wherein the scan input conversion circuit executes parallel to serial conversion using a 2-input 1-output selection circuit.

3. The scan test circuit as claimed in claim 1, wherein the scan output conversion circuit executes serial to parallel conversion using a 1-input 2-output selection circuit.

4. The scan test circuit as claimed in claim 1, wherein the scan input conversion circuit executes serial to parallel conversion using a 1-input 2-output selection circuit.

5. The scan test circuit as claimed in claim 1, wherein the scan output conversion circuit executes parallel to serial conversion using a 1-input 2-output serial selection circuit.
